(19) United States
(12) Patent Application Publication
(10) Pub. No.: US 2026/0127030 A1
(43) Pub. Date: May 7, 2026

(54) COMPUTER-IMPLEMENTED METHODS AND SYSTEMS FOR OPTIMIZING RESOURCE ALLOCATION

(71) Applicant: The Toronto-Dominion Bank, Toronto (CA)

(72) Inventors: Anna Keshabyan-Prasad, Maple Ridge (CA); Sarah Kahlon Sinha, Toronto (CA); Sheldon Lu-Ming Tung, Markham (CA); Dhiren Kakkar, Toronto (CA); Yu Ling Ip, Markham (CA); Sneha Desai, Toronto (CA); Jean-Christophe Bouëtté, Montreal (CA)

(21) Appl. No.: 18/935,266

(22) Filed: Nov. 1, 2024

(51) Int. Cl. G06F 9/50

(52) U.S. Cl. CPC G06F 9/5005

(57) ABSTRACT

Computer systems and methods for determining a difference (e.g., decrease or increase) from a resource allocation in an initial proposal for a recipient to form an updated proposal based on the recipient's sensitivity to the difference, wherein the recipient's sensitivity to the difference is determined from a sensitivity model which maps a set of one or more attributes of the recipient to one of a plurality of sensitivity levels. A difference (e.g., discount or increase) from the resource allocation in the initial proposal is then determined from the identified sensitivity level. The sensitivity model may be generated by statistical analysis of historical records for the resource.

### TECHNICAL FIELD

The disclosed example embodiments relate to computer-implemented methods and systems for determining a recommended difference (e.g., decrease or increase) from an initial proposal for resource allocation.

### BACKGROUND

There are many situations where a first entity is in charge of allocating resources to a second entity. In some cases, the first entity may make an initial proposal for resource allocation to the second entity; and if the second entity is not satisfied with the initial proposal, the first entity may make an updated proposal. The resource that is allocated may be any suitable resource such as, but not limited to, computing resources. For example, in a computing system an operating system may initially propose allocating a process a certain, e.g., default, number of computing resources (e.g., a certain amount of memory and/or a certain amount of central processing unit (CPU) time). The process may not be satisfied with the default number of resources that it has been allocated and thus may request an updated proposal. The operating system may then provide an updated proposal that allocates an increased number of resources (e.g., an increased amount of memory and/or increased CPU time) to the process.

The operating system may want to optimize the trade-off between (i) allocating the process sufficient resources so that the process will accept the proposal and (ii) not allocating too many resources so that the operating system can support other processes. It may be desirable in such situations to be able to automatically select an allocation of resources for the updated proposal that balances such competing interests.

### SUMMARY

The following summary is intended to introduce the reader to various aspects of the detailed description, but not to define or delimit any invention.

A first aspect provides a system for determining a difference from a resource allocation in an initial proposal for a recipient to form an updated proposal for the recipient, the system comprising: a memory, a communication interface, and at least one processor operatively coupled to the memory and the communication interface; the at least one processor configured to: generate a sensitivity model by: obtaining a set of one or more recipient attributes, obtaining a plurality of historical records, each historical record comprising information indicating: a difference between a resource allocation in an initial proposal and an updated proposal for a historical recipient, whether the resource was provided to the historical recipient, and settings for the set of one or more recipient attributes, and sub-dividing the plurality of historical records into a plurality of final segments using statistical analysis such that historical records in a same final segment have settings for the one or more recipient attributes that are correlated with a similar level of sensitivity to the difference between the resource allocation in the initial proposal and the updated proposal; and select a difference from the resource allocation in the initial proposal for the recipient based on the sensitivity model.

Selecting the difference from the resource allocation in the initial proposal for the recipient based on the sensitivity model may comprise: receiving, for the recipient, a setting for each recipient attribute in the set of one or more recipient attributes; mapping, based on the settings for the set of one or more recipient attributes, the recipient to a final segment; and identifying the difference from the resource allocation in the initial proposal for the recipient based on the final segment mapped to the recipient.

Generating the sensitivity model may further comprise associating each final segment with a difference from the resource allocation in the initial proposal; and identifying the difference from the resource allocation for the recipient based on the final segment mapped to the recipient may comprise identifying the difference from the resource allocation in the initial proposal associated with the final segment mapped to the recipient as the difference from the resource allocation in the initial proposal for the recipient.

Each final segment of the plurality of final segments may be associated with a different sensitivity tier of a plurality of sensitivity tiers.

Sub-dividing the plurality of historical records into the plurality of final segments using statistical analysis may comprise: sub-dividing the plurality of historical records into a plurality of segments, wherein all the historical records in a same segment of the plurality of segments have a same set of settings for the set of one or more recipient attributes; performing a correlation analysis on the historical records within each segment to identify a relationship between (i) the difference between the resource allocation in the initial proposal and the updated proposal and (ii) providing the resource to the historical recipient; assigning each segment a correlation-based sensitivity rating based on the correlation analysis; dividing the segments into a plurality of correlation-based groups based on the correlation-based sensitivity ratings; and combining the segments in each correlation-based group of the plurality of correlation-based groups to form the final segments.

Performing the correlation analysis on the historical records in a segment may comprise calculating a correlation coefficient based on the historical records in the segment, wherein the correlation coefficient represents a relationship between (i) the difference between the resource allocation in the initial proposal and the updated proposal, and (ii) and providing the resource to the historical recipient.

The correlation coefficient may be a Pearson correlation coefficient.

The correlation-based sensitivity rating for each segment may be equal to the correlation coefficient for that segment.

Dividing the segments into the plurality of correlation-based groups based on the correlation-based sensitivity ratings may comprise dividing the segments into quintiles based on the correlation-based sensitivity ratings.

Sub-dividing the plurality of historical records into the plurality of final segments using statistical analysis may further comprise, prior to performing the correlation analysis: assigning each segment a discretion-based sensitivity rating based on the differences between the resource allocation in the initial proposal and the updated proposal in the historical records in that segment; dividing the segments with less than a predetermined number of historical records into a plurality of discretion-based groups based on the discretion-based sensitivity rating; and combining the segments in each discretion-based group to form a new segment.

The discretion-based sensitivity rating for each segment may be an average difference between the resource allocation in the initial proposal and the updated proposal in the historical records in that segment.

The resource may be a financial resource, and the initial proposal may allocate an initial price or rate for the financial product.

The resource may be a mortgage for a property, the initial proposal may allocate an initial rate for the mortgage, and the difference from the resource allocation in the initial proposal and the updated proposal may be a discount from the initial rate for the mortgage.

The set of one or more recipient attributes comprises one or more of: whether or not the property is a rental property, a number of days before a closing of the property, whether the recipient is a builder, a construction type of the property, a term type of the mortgage, and an amount of the mortgage.

The set of one or more recipient attributes may comprise X recipient attributes that are most statistically significant to sensitivity and X is an integer greater than or equal to one.

A second aspect provides a method for determining a difference from a resource allocation in an initial proposal to form an updated proposal, the method executed in a computing environment comprising one or more processors, a communication interface, and memory, and the method comprising: generating a sensitivity model by: obtaining a set of one or more recipient attributes, obtaining a plurality of historical records, each historical record comprising information indicating: a difference between a resource allocation in an initial proposal and an updated proposal for a historical recipient, whether the resource was provided to the historical recipient, and settings for the set of one or more recipient attributes, and sub-dividing the plurality of historical records into a plurality of final segments using statistical analysis such that historical records in a same final segment have settings for the one or more recipient attributes that are correlated with a similar level of sensitivity to the difference between the resource allocation in the initial and updated proposals; and selecting a difference from the resource allocation in the initial proposal for the recipient based on the sensitivity model.

Selecting the difference from the resource allocation in the initial proposal for the recipient based on the sensitivity model may comprise: receiving, for the recipient, a setting for each recipient attribute in the set of one or more recipient attributes; mapping, based on the settings for the set of one or more recipient attributes for the recipient, the recipient to a final segment; and identifying the difference from the resource allocation in the initial proposal for the recipient based on the final segment mapped to the recipient.

Sub-dividing the plurality of historical records into the plurality of final segments using statistical analysis may comprise: sub-dividing the plurality of historical records into a plurality of segments, wherein all the historical records in a same segment of the plurality of segments have a same set of settings for the set of one or more recipient attributes; performing a correlation analysis on the historical records within each segment to identify a relationship between (i) the difference between the resource allocation in the initial proposal and the updated proposal, and (ii) providing the resource to the historical recipient; assigning each segment a correlation-based sensitivity rating based on the correlation analysis; dividing the segments into a plurality of correlation-based groups based on the correlation-based sensitivity ratings; and combining the segments in each correlation-based group of the plurality of correlation-based groups to form the final segments.

Sub-dividing the plurality of historical records into the plurality of final segments using statistical analysis may further comprise, prior to performing the correlation analysis: assigning each segment a discretion-based sensitivity rating based on the differences between the resource allocation in the initial proposal and the updated proposal in the historical records in that segment; dividing the segments with less than a predetermined number of historical records into a plurality of discretion-based groups based on the discretion-based sensitivity rating; and combining the segments in each discretion-based group to form a new segment.

According to some aspects, the present disclosure provides a non-transitory computer-readable medium storing computer-executable instructions. The computer-executable instructions, when executed, configure a processor or a set of processors to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a block diagram of an example computing system for determining a recommended difference (e.g., decrease or increase) from a resource allocation in an initial proposal for a recipient to form an updated proposal wherein the recommended difference is based on the recipient's sensitivity to the difference;

FIGS. 2A to 2F are example graphs illustrating the relationship between example recipient attributes and sensitivity for an example set of historical records;

FIG. 3 is a flow diagram of an example method for generating a sensitivity model;

FIG. 4 is a flow diagram of an example method for sub-dividing historical records into a plurality of final segments in accordance with sensitivity;

FIG. 5 is a flow diagram of an example method for determining a recommended difference from a resource allocation in an initial proposal for a recipient based on a sensitivity model;

FIG. 6 is an example graphical user interface which may be provided by an adjustment module;

FIG. 7 is a graph of example cumulative elasticity gain curves; and

FIG. 8 is a block diagram of an example computer which may be used to implement all or a portion of the system of FIG. 1 and/or execute all or a portion of the method of FIG. 3, the method of FIG. 4 and/or the method of FIG. 5.

### DETAILED DESCRIPTION

As described above, there are many situations where a first entity is in charge of allocating resources to a second entity. In some cases, the first entity may make an initial proposal for resource allocation to the second entity; and if the second entity is not satisfied with the initial proposal, the first entity may make an updated proposal

In some cases, the resource may be a computing resource. For example, an operating system of a computing system may initially propose allocating the process a certain, e.g., default, number of computing resources (e.g., a certain amount of memory and/or a certain about of central processing unit (CPU) time). The process may not be satisfied with the default number of resources that it has been allocated and thus may request an updated proposal. The operating system may then provide an updated proposal that allocates the process an increased number of resources (e.g., an increased amount of memory and/or increased CPU time). The process may then accept or reject the updated proposal based on criteria that are known to the process and different processes may use different criteria.

In other cases, the resource may be a financial resource. For example, a mortgage lender may initially proposal allocating a customer an initial interest rate for a mortgage and if the customer is not satisfied with the initial interest rate, the customer can request a discount from the initial interest rate. The mortgage lender may then propose allocating the customer a discounted interest rate which the customer may decide to accept or reject. Similar situations may also arise for other negotiable financial resources. For example, a financial institution may initially proposed allocating a customer an initial rate for a guaranteed investment certificate (GIC) and if the customer is not satisfied with the initial rate, the customer can request an increase to the initial rate. The financial institution may then propose allocating the customer an increased rate which the customer may decide to accept or reject.

As noted above, in such situations, the first entity may want to find a balance between (i) increasing or decreasing the initial proposal by a higher amount to increase the likelihood that the recipient will accept the updated proposal; and (ii) increasing or decreasing the initial proposal by a lower amount so as to not waste resources (e.g., computing resources or financial resources). For example, where the first entity is the operating system of a computing system, the recipient is a process and the resource is a computing resource, the operating system may want to optimize the trade-off between (i) allocating the process sufficient resources so that the process will accept the updated proposal and (ii) not allocating too many resources so that the operating system can still support other processes. It is therefore desirable to be able to automatically identify an amount of the difference (e.g., increase or decrease) from the initial proposal to form the updated proposal that balances these competing interests.

Accordingly, described herein are systems and methods for determining an optimum or recommended difference (e.g., decrease or increase) from a resource allocation in an initial proposal for a recipient that is to form an updated proposal based on the recipient's sensitivity to the difference, wherein the recipient's sensitivity to the difference is determined from a sensitivity model which maps a set of one or more attributes of the recipient to one of a plurality of sensitivity levels. An optimal or recommended difference (e.g., decrease or increase) from the resource allocation in the initial proposal that is to form the updated proposal is then determined from the identified sensitivity level.

The sensitivity model may be generated from historical records for the resource. Each historical record comprises information indicating the difference (e.g., decrease or increase) from a resource allocation in an initial proposal and an updated proposal, whether the updated proposal resulted in the resource being provided to the recipient, and the setting for each recipient attribute of the set of one or more recipient attributes. For example, if the resource is a financial resource, such as a mortgage, and the initial proposal and updated proposal allocate an interest rate for the mortgage, then each historical record may comprise information indicating the difference from the rate allocated in the initial proposal and the rate allocated in the updated proposal, whether or not the mortgage was ultimately funded, and the settings for the set of one or more recipient attributes. Where, however, the resource is a computing resource which is, for example, allocated to a process, then each historical record may comprise information indicating the difference between the amount of the computing resource allocated to the process in the initial proposal and the amount of the computing resource allocated to the process in the updated proposal, whether or not the process accepted the updated proposal, and the settings for the set of one or more recipient attributes. The sensitivity model may be generated by performing statistical analysis (and specifically correlation analysis) on the historical records to identify how the set of one or more attributes are correlated to, or indicate, sensitivity.

In some cases, generating the sensitivity model may comprise sub-dividing the historical records into a set of final segments based on a statistical analysis of the historical records (and specifically correlation analysis) such that the historical records in the same final segment have settings for the set of one or more recipient attributes that are correlated with a similar level of sensitivity to the difference. In this manner each final segment may be associated with a different sensitivity level or tier. For example, in some cases, the historical records may be divided into three final segment—one segment associated with low sensitivity, one segment associated with medium sensitivity, and one segment associated with high sensitivity. In other cases, the historical records may be divided into five final segments wherein one final segment is associated with a sensitivity level of 0-20% (least sensitive), a second final segment is associated with a sensitivity level of 21-40%, a third final segment is associated with a sensitivity level of 41-60%, a fourth final segment is associated with a sensitivity level of 61-80% and a fifth final segment is associated with a sensitivity level of 81-100% (most sensitive).

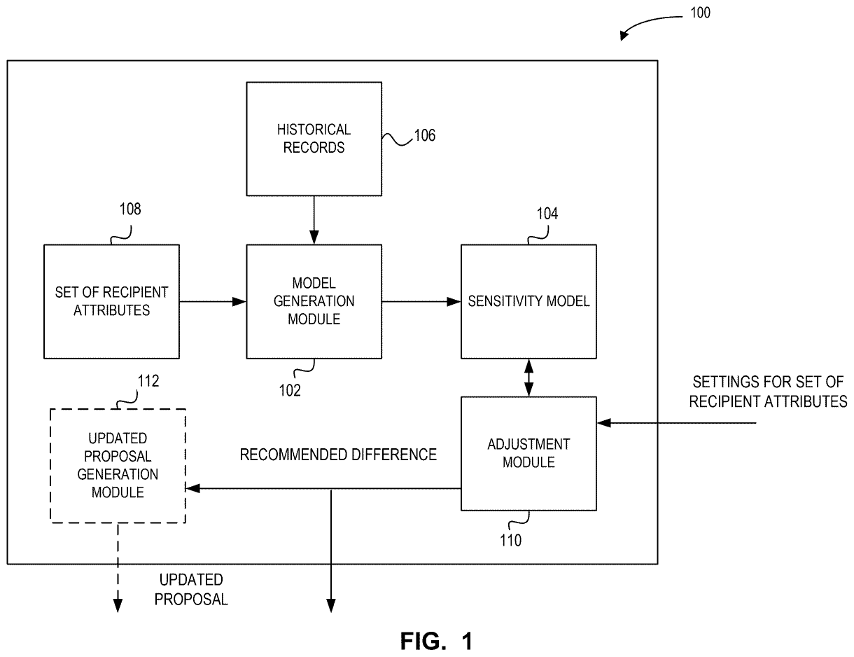

Reference is now made to FIG. 1 which illustrates an example computing system 100 for determining an optimum or recommended difference (e.g., decrease or increase) from a resource allocation in an initial proposal for a recipient to form an updated proposal based on the recipient's sensitivity to the difference. The computing system 100 comprises (i) a model generation module 102 which is configured to generate a sensitivity model 104 based on a set of historical records 106 and a set of one or more recipient attributes 108; and (ii) an adjustment module 110 that is configured to determine, using the sensitivity model 104, an optimal or recommended difference (e.g., decrease or increase) from the resource allocation in the initial proposal for the recipient that is to form an updated proposal for the recipient.

Each recipient has a plurality of attributes associated therewith which describe the recipient and/or the resource that the recipient is attempting to obtain. For example, where the resource being allocated is a mortgage the recipient attributes may describe whether or not the customer is a builder, the type of mortgage they are trying to obtain, the age of the customer, the income of the customer etc.

The set of one or more recipient attributes 108 comprises recipient attributes that are to be used to generate the sensitivity model. In some cases, the set of one or more recipient attributes 108 may be recipient attributes which have been identified as being correlated to a recipient's sensitivity to the difference between the resource allocation in the initial proposal and the updated proposal. A recipient's sensitivity to the difference between the resource allocation in the initial proposal and the updated proposal is the degree to which the difference (e.g., deduction in the rate) influences the recipient's acceptance of the updated proposal. A recipient attribute is relevant to sensitivity if a recipient's sensitivity varies based on the setting for that attribute. In other words, a recipient attribute is relevant to sensitivity if the attribute's setting is an indicator of sensitivity. The set of recipient attributes 108 may be identified in any suitable manner. In some cases, the set of recipient attributes may be identified empirically from a set of historical records. In some cases, the recipient attributes may be the X most statistically significant entity attributes to sensitivity, wherein X is an integer greater than or equal to one. In one example X=6.

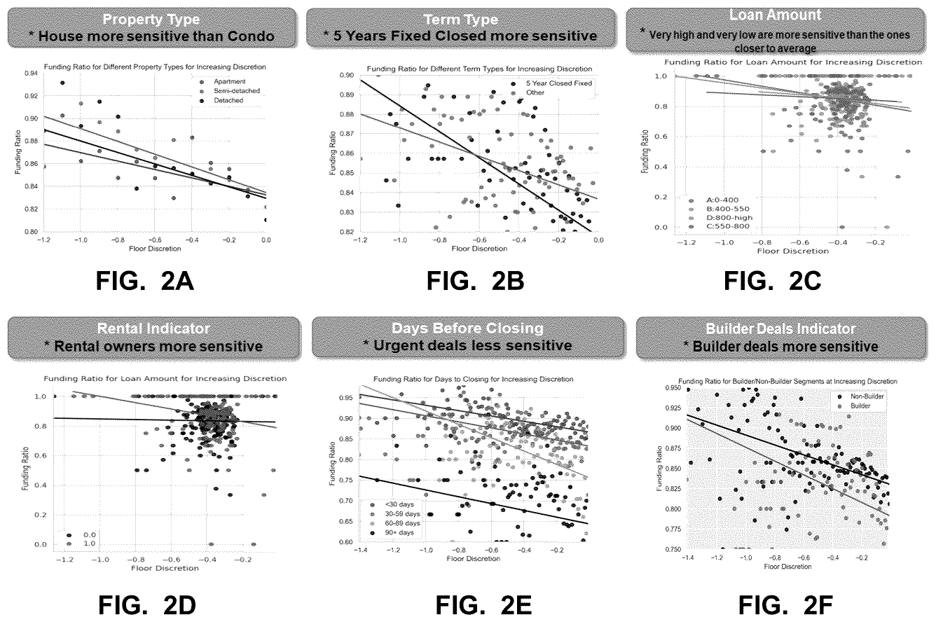

For example, as shown in the graphs in FIGS. 2A-2F, it was determined empirically that the following recipient attributes were the six most statistically significant recipient attributes to rate sensitivity for a set of mortgages. Thus, in one example, these six recipient attributes were used to generate a sensitivity model for mortgages and specifically mortgage rates.
Rental (i.e., whether the mortgage was for a rental property or a non-rental property).
Days Before Closing (i.e., the number of days before the property to which the mortgage is to be applied is closing)
Builder (i.e., whether the customer is a builder or not).
Construction Type (i.e., whether the property relates to a detached house, a semi-detached house, or a condominium/apartment)
Term Type (i.e., the term of the mortgage, such as, but not limited to, 5 year fixed)
Loan Amount (i.e., the value of the mortgage)

Specifically, each of FIGS. 2A to 2F shows a graph of Floor Discretion vs Funding Ratio for a specific recipient attribute for a number of different settings for that attribute, wherein “Floor Discretion” is the discount that was proposed with respect to an initial (e.g., floor) rate, and “Funding Ratio” is the percentage of mortgages that were funded (e.g., accepted by the customer). These graphs show whether a higher discount affected the funding ratio. FIG. 2A shows Floor Discretion vs. Funding Ratio for the property type attribute; FIG. 2B shows Floor Discretion vs. Funding Ratio for the term type attribute; FIG. 2C shows Floor Discretion vs. Funding Ratio for the loan amount attribute; FIG. 2D shows Floor Discretion vs. Funding Ratio for the rental attribute; FIG. 2E shows Floor Discretion vs. Funding Ratio for the days before closing attribute; and FIG. 2F shows Floor Discretion vs. Funding Ratio for the builder attribute.

As shown in FIG. 2A, with respect to the construction type attribute (which may also be referred to as the property type attribute) it was determined that when a mortgage related to a house (semi-detached or detached) customers were more sensitive to the difference (i.e., discount to the mortgage rate) than when the mortgage related to an apartment or condominium; as shown in FIG. 2B, with respect to the term type attribute, it was determined that when a mortgage was a 5 year closed fixed mortgage the customer was more sensitive to the difference (i.e., discount to the mortgage rate) than when the mortgage was any other type; as shown in FIG. 2C, with respect to the loan amount attribute, it was determined that when the mortgage was for a very high (≥$800,000) or very low (≤$500,000) amount, the customer was more sensitive to the difference (i.e., discount in the mortgage rate) than when the mortgage was for an amount closer to the average; as shown in FIG. 2D, with respect to the rental indicator attribute, it was determined that when a mortgage related to a rental property the customer was more sensitive to the difference (i.e., discount in the mortgage rate) then when the mortgage did not relate to a rental property; as shown in FIG. 2E, with respect to the days before closing attribute, it was determined that when a mortgage related to an urgent property closing (e.g., a closing <30 days) the customer was more sensitive to the difference (i.e., discount in the mortgage rate) than when the mortgage related to a less urgent property closing; and as shown in FIG. 2F, with respect to the builder indicator attribute, it was determined that when the customer was a builder they were more sensitive to the difference (i.e., discount in the mortgage rate) than when the customer was a non-builder.

In some cases, to enable the historical records 106 to be sorted based on their relevant recipient attribute settings, each recipient attribute in the set of one or more recipient attributes 108 may have a limited set of settings or options. For example, the rental attribute may be set to either rental (e.g., “Y”) or not-rental (e.g. “N”); the days before closing attribute may be set to one of a plurality of different days before closing ranges, such as <30 days, 30-59 days, 60-89 days and 90+days; the builder attribute may be set to either builder (e.g., “Y”) or non-builder (e.g., “N”); the construction type attribute may be set to one of apartment/condominium, detached house or semi-detached house; the term type attribute may be set to one of a plurality of different mortgage term types such as 5 year closed fixed and other; and the loan amount attribute may be set to one of a plurality of loan amount ranges such as, but not limited to, 0-$500,000, $500,000-$600,000, $600,0000-$800,000, and >$800,0000.

The historical records 106 are records of historical or past resource allocation proposals. Each historical record comprises information indicating the difference (e.g., decrease or increase) from a resource allocation in an initial proposal and an updated proposal, whether the proposal or updated proposal resulted in the resource being provided to the recipient, and the setting for the set of recipient attributes for the recipient. For example, if the resource is a mortgage and the initial proposal allocates a rate (i.e., mortgage rate), then each historical record may comprise the discount from the rate allocated in the initial proposal to the rate allocated in an updated proposal, whether or not the mortgage was ultimately funded, and a setting for each recipient attribute in the set of one or more recipient attributes 108. Each record may also comprise other information such as, but not limited to, settings for other recipient attributes etc. Where, however, the resource is a computing resource, then each historical record may comprise the increase from the amount of the computing resource allocated in the initial proposal and the updated proposal, whether or not the process accepted the proposal or the updated proposal, and the settings for the set of recipient attributes 108. The historical records 106 may be stored in memory (of a computing device) which is accessible by the model generation module 102.

The model generation module 102 is configured to generate a sensitivity model 104 from the set of historical records 106 and the set of one or more recipient attributes 108. The sensitivity model 104 maps settings for the set of one or more recipient attributes to sensitivity to the difference between the allocation in the initial proposal and the updated proposal. In other words, the sensitivity model 104 can identify the sensitivity of a recipient to the difference between the allocation in the initial proposal and the updated proposal based on the one or more recipient attributes for that recipient. For example, where the resource is a mortgage, and the initial proposal and the updated proposal allocate a mortgage rate, the sensitivity model 104 may be able to determine a customer's sensitivity to the difference in the mortgage rate between the initial proposal and the updated proposal (i.e., degree to which the mortgage rate, and specifically a reduction in the mortgage rate, influences the customer's acceptance of a proposal/updated proposal) based on the settings for the set of recipient attributes. In some cases, the sensitivity model 104 may also associate sensitivity (or sensitivity levels) with a recommended difference (e.g., decrease or increase) from an allocation in the initial proposal so that once a recipient's sensitivity has been identified from the sensitivity model 104 a recommended difference for that recipient can be provided.

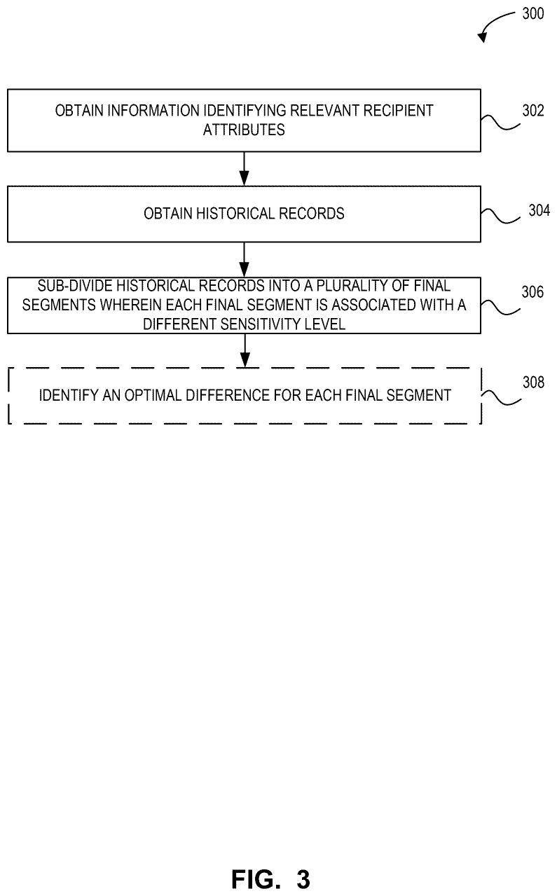

In some cases, the sensitivity model 104 is generated by the model generation module 102 by performing statistical analysis on the historical records to identify how the set of recipient attributes indicate sensitivity to the difference between the allocation of the resource in the initial proposal and the updated proposal. FIG. 3 illustrates an example method 300 for generating a sensitivity model 104 from historical records and a set of recipient attributes which may be implemented by the model generation module 102.

The model generation module 102 may be implemented by one or more computers. For example, in some examples, the model generation module 102 may be software (e.g., a set of computer executable instructions) which can be executed by the processor of one or more computers.

The adjustment module 110 is configured to determine an optimum or recommended difference (e.g., decrease or increase) from a resource allocation in an initial proposal for recipient to form an updated proposal based on the sensitivity model 104. For example, the adjustment module 110 may be configured to receive a setting for each of the recipient attributes 108 for a new recipient and use the sensitivity model 104 to determine the sensitivity of the new recipient to the difference based on the settings for the recipient attributes. An optimum or recommended difference can then be determined based on the sensitivity. For example, where the resource is a mortgage and the initial proposal allocates an initial (e.g., floor) mortgage rate, an optimum or recommended discount from the initial (e.g., floor) rate for the customer may be determined based on the identified sensitivity. In some cases, the adjustment module 110 is configured to identify an optimum, or recommended, difference based on the sensitivity. In other cases, the sensitivity model 104 itself may be configured to determine both sensitivity and an optimum or recommended difference. The adjustment module 110 may be configured to perform the determination of an optimal or recommended difference for multiple different new recipients.

In some cases, as described in more detail below, the adjustment module 110 may be configured to provide a (graphical) user interface which may allow a user to provide the settings for the set of one or more recipient attributes and/or in which the recommended difference may be displayed.

The adjustment module 110 may be implemented by one or more computers. For example, in some examples, the adjustment module 110 may be software (e.g., a set of computer executable instructions) which can be executed by the processor of one or more computers. In some cases, the adjustment module 110 may be implemented by a spreadsheet macro (e.g., a Microsoft™ Excel™ macro).

In some cases, the same computer (or set of computers) that implements the model generation module 102 may also implement the adjustment module 110. In other cases, one computer (or set of computers) may implement the model generation module 102, and a different computer (or different set of computers) may implement the adjustment module 110. For example, in some cases, the model generation module 102 may be implemented on a (centralized) computer or server to generate the sensitivity model 104, and once the sensitivity model 104 has been generated a copy of the sensitivity model 104 may be deployed, along with the adjustment module 110, on one or more user computers where a user of a user computer can interact with the adjustment module 110 to obtain a recommended difference for each of one or more new recipients.

In some cases, the computing system 100 may also comprise a updated proposal generation module 112 which is configured to generate the updated proposal (e.g., discounted mortgage rate) for a new recipient (e.g., customer) based on the optimum or recommended difference identified by the adjustment module 110. In some cases, the updated proposal generation module 112 may be configured to calculate the profitability of any proposal and the final resource allocation (e.g., mortgage rate) proposed to the customer is based on the determined profitability and the optimum or recommended difference. For example, where the resource is a mortgage, the updated proposal generation module 112 may be configured to generate the profitability by determining the cost of funding the mortgage and the operating costs associated with the mortgage and subtracting that from the customer mortgage rate. For example, if an initial customer mortgage rate is 5.24% and it is determined by the updated proposal generation module 112 that the cost of funding the mortgage is 4.64% then the gross margin is 0.60%. It may then be determined that the operating costs for the mortgage are between 0.30 and 0.45% which puts the net margin between 0.15% and 0.30%. If the adjustment module 110 determines that the recommended rate discount is 20 bps (basis percentage points) then this may result in a net margin of 0.05% to 0.2% which may be used to make a decision on whether to propose the discount or not.

The updated proposal generation module 112 may be implemented by one or more computers. For example, in some examples, the updated proposal generation module 112 may be software (e.g., a set of computer executable instructions) which can be executed by the processor of one or more computers.

Reference is now made to FIG. 3 which illustrates an example method 300 for generating a sensitivity model. The method 300 may be executed by the model generation module 102 of FIG. 1.

The method 300 begins at block 302 where the model generation module 102 obtains (e.g., retrieves or receives) information identifying a set of one or more recipient attributes (e.g., the set of one or more recipient attributes 108 of FIG. 1) to be used to generate the model. For example, where the resource is a mortgage and the proposal and the updated proposal allocate a mortgage rate, the model generation module 102 may obtain information identifying the six recipient attributes described above—e.g., rental, days before closing, builder, construction type, term type and loan amount. The identified set of one or more recipient attributes may be referred to as the relevant recipient attributes. Once the information identifying the set of relevant recipient attributes have been obtained, the method 300 proceeds to block 304.

At block 304, the model generation module 102 obtains (e.g., retrieves or receives) a set of historical records for the resource. The set of historical records comprise historical or past proposals for resource allocation. Each historical record comprises information indicating the difference (e.g., decrease or increase) from an allocation of the resource in an initial proposal and an updated proposal, whether the proposal/updated proposal resulted in the resource being provided to the recipient, and the settings for the set of relevant recipient attributes for the recipient For example, if the resource is a mortgage and the proposal allocates an interest rate (i.e., mortgage interest rate), then each historical record may comprise the discount from an initial rate allocated to a customer in an initial proposal and the rate that was allocated to the customer in an updated proposal, whether or not the mortgage was ultimately funded, and a setting for each relevant recipient attribute in the set of one or more recipient attributes 108. Each record may also comprise other information such as, but not limited to, settings for other recipient attributes etc. Once the set of historical records have been obtained, the method 300 proceeds to block 306.

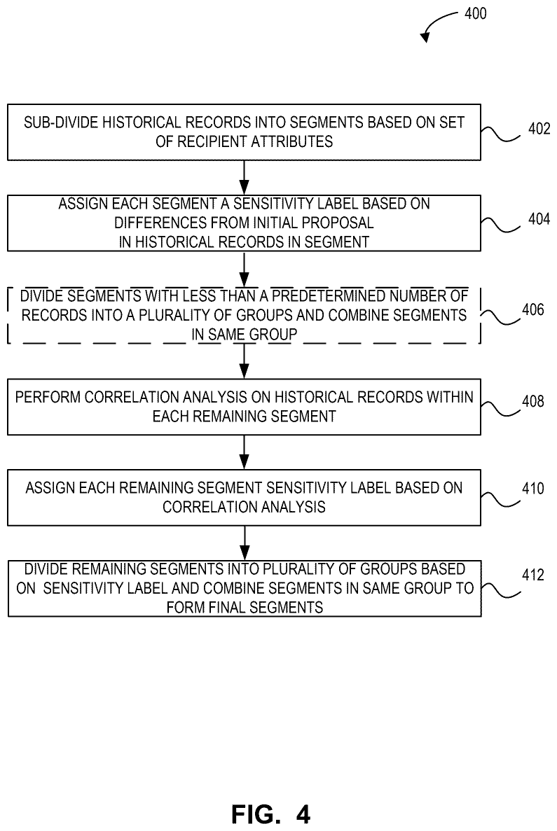

At block 306, the model generation module 102 sub-divides the historical records obtained in block 304 into a plurality of final segments based on statistical analysis of the historical records (and specifically correlation analysis of the historical records) such that the historical records in the same final segment have settings for the relevant recipient attributes identified in block 302 that are correlated with a similar level of sensitivity to the difference. In this manner each final segment is associated with a different sensitivity level or tier. For example, in some cases, the historical records may be divided into three final segments wherein one segment is associated with low sensitivity, a second segment is associated with medium sensitivity, and a third segment is associated with high sensitivity. In other cases, the historical records may be divided into five final segments wherein one final segment is associated with a sensitivity level of 0-20% (least sensitive), a second final segment is associated with a sensitivity level of 21-40%, a third final segment is associated with a sensitivity level of 41-60%, a fourth final segment is associated with a sensitivity level of 61-80% and a fifth final segment is associated with a sensitivity level of 81-100% (most sensitive). An example method for sub-dividing the historical records into a plurality of final segments using statistical analysis (and specifically correlation analysis) is described with respect to FIG. 4.

Once the plurality of final segments has been identified a sensitivity model has been formed—i.e., the final segments form the sensitivity model. Specifically, as described in more detail below, the plurality of final segments can be used to identify the sensitivity of a new recipient. In particular, each historical record in a final segment will have settings for the relevant recipient attributes and if a new recipient has settings for the relevant recipient attributes that are the same as a historical record in a final segment, then it can be estimated or predicted that the sensitivity of the new recipient has the same sensitivity as that final segment. For example, if the settings for the relevant recipient attributes for a new recipient match the settings for the relevant recipient attributes for a historical record in a final segment associated with low sensitivity, then it can be estimated or predicted that the new recipient has low sensitivity to the difference.

Once the plurality of final segments has been identified, the method 300 may end or the method 300 may proceed to block 308.

At block 308, the model generation module 102 identifies, for each final segment, a recommended difference (e.g., decrease or increase) from the resource allocation in an initial proposal. In some cases, the recommended difference (e.g., discount or increase) from the resource allocation in the initial proposal for a segment may be determined empirically. In some examples, the optimal difference may be determined from a NIAT (net income after tax) vs difference (e.g., decrease or increase) plot. Once an optimal difference (e.g., decrease or increase) from the resource allocation in an initial proposal has been determined for each final segment the method 300 may end.

Reference is now made to FIG. 4 which illustrates an example method for sub-dividing the historical records into a plurality of final segments. In other words, the method 400 of FIG. 4 is an example method for implementing block 306 of the method 300 of FIG. 3. The method 300 of FIG. 3 may, for example, be implemented by the model generation module 102 of FIG. 1.

The method 400 begins at block 402 where the model generation module 102 sub-divides the historical records into an initial set of segments wherein each historical record in the same segment comprises the same settings or options for the relevant recipient attributes (e.g., the set of one or more recipient attributes identified in block 302). In other words, each segment comprises historical records that have the same relevant recipient attribute settings.

For example, if the six recipient attributes described above (rental, days to close, builder, property type, term type, loan amount) are the relevant recipient attributes then one segment may comprise historical records with the following attribute settings (rental=N, days to close=60+days, builder=N, construction type=detached, term=5 year closed fixed, and Loan Amount=Tier 1) and another segment may comprise historical records with the following attribute settings (rental=N, days to close=60+days, builder=Y, construction type=semi-detached, term=5 year closed fixed, and Loan Amount=Tier 2).

An example set of 20,000 historical records related to mortgage proposals was sub-divided into more than 500 segments using the six recipient attributes described above. Once the historical records have been divided into segments based on the settings for the relevant recipient attributes, the method 400 may proceed to block 404 or the method 400 may proceed directly to block 408 (i.e., blocks 404 and 406 are optional).

At block 404, the model generation module 102 assigns each segment a sensitivity label or rating (e.g., a numerical value indicating sensitivity to the difference) based on the differences (e.g., discount or increase) between the resource allocation in the initial proposal and the updated proposal in the historical records in that segment. This sensitivity label or rating assigned in block 404 may be referred to as the discretion-based sensitivity label or rating. In some cases, the model generation module 102 may be configured to set the label or rating for each segment to the average difference (e.g., decrease or increase) between the resource allocation in the initial proposal and the updated proposal in the historical records in that segment. Once a discretion-based sensitivity label or rating has been assigned to each segment identified in block 402, the method 400 proceeds to block 406.

At block 406, the model generation module 102 divides the segments with less than a predetermined number of historical records into a plurality of groups based on the sensitivity labels assigned in block 404 and combines the segments in each group to form a new segment. Specifically, to make the correlation analysis in block 408 more meaningful, the segments that have less than a predetermined number (e.g., 30) of historical records may be sorted into a plurality of groups based on the discretion-based sensitivity labels or ratings assigned in block 404. The segments in the same group are then combined to form a new, larger, segment. In some cases, the segments with less than the predetermined number (e.g., 30) of historical records are divided equally into two groups such that the segments with the highest labels or ratings assigned in block 404 (e.g., the segments with the highest average differences) are in one group and the segments with the lowest labels or ratings assigned in block 404 (e.g., the segments with the lowest average differences) are in the other group.

In the example above, with roughly 20,000 historical mortgage application records which resulted in more than 500 initial segments, combining initial segments with less than 30 historical records reduced the number of segments to 62 segments.

Once the segments with less than a predetermined number of historical records have been combined into a plurality of larger segments, the method 400 proceeds to block 408.

At block 408, the model generation module 102 performs a correlation analysis on the historical records within each remaining segment (i.e., each combined segment (if blocks 404 and 406 were implemented) and each initial segment that was not combined with another segment) to identify the relationship between the differences between the resource allocation in the initial and updated proposals in the segment and the delivering of the resource to the recipient. In some cases, performing a correlation analysis on the historical records within a segment comprises generating a correlation coefficient from the historical records within that segment that represents the relationship between (i) the difference (e.g., decrease or increase) between the resource allocation in the initial and updated proposals, and (ii) the resource ultimately being provided (e.g., the mortgage being funded, or the computing resources being provided to the process). In other words, the correlation analysis may determine whether, within a segment, the greater the difference (e.g., decrease or increase) between the resource allocation in the initial and updated proposals, the more likely the resource will be provided (e.g., the mortgage will be funded, or the computing resources provided).

A correlation coefficient is a statistic measuring the strength of the linear relationship between two variables. Any suitable correlation coefficient may be generated. Two common correlation coefficients are the Pearson correlation coefficient (PCC) and the Spearman correlation coefficient. In some cases, the correlation coefficient may by the Pearson correlation coefficient. The Pearson correlation coefficient is a number between −1 and +1 that measures the strength and direction of the relation between two variables. In this example the two variables are (1) the difference (e.g., decrease or increase) between the resource allocation in the initial and updated proposals and (2) whether the resource was ultimately provided to the recipient (e.g., whether the mortgage was funded, or the computing resources were provided to the process). Once a correlation analysis has been performed on the historical records within each remaining segment, the method 400 proceeds to block 410.

At block 410, the model generation module 102 assigns each remaining segment (i.e., each combined segment generated in block 406 and each initial segment generated in block 402 that was not combined with another segment) a sensitivity label or rating based on the correlation analysis performed in block 408. The sensitivity label assigned in block 410 may be referred to as the correlation-based sensitivity label. In some cases, the label or rating that is assigned to each remaining segment is equal to the correlation coefficient for that segment. For example, if the correlation coefficient for a segment is 0.5 then that segment may be assigned a correlation-based sensitivity label or rating of 0.5. Once a correlation-based sensitivity label has been assigned to each remaining segment, the method 400 proceeds to block 412.

At block 412, the model generation module 102 divides the remaining segments (i.e., each combined segment generated in block 406 and each initial segment generated in block 402 that was not combined with another segment) into a plurality of groups based on the correlation-based sensitivity labels or ratings assigned in block 410 and combines the segments in each group to form a set of final segments. The number of final segments (and thus the number of groups the remaining segments are sub-divided into) may be relatively small (e.g., less than 10) so as to allow the model to be generated on, and the model used on, a basic computer with limited resources.

In some examples, the number of final segments is five (and thus the number of groups the remaining segments are sub-divided into is five). In these cases, the remaining segments may be divided into quintiles based on the correlation-based sensitivity labels or ratings assigned in block 410, and the segments in each quintile are combined to form final segments. For example, a first final segment may represent the first quintile (i.e., the segments with the lowest fifth of correlation-based sensitivity labels), a second final segment may represent the second quintile (i.e., the segments with the next fifth of correlation-based sensitivity labels), etc. In this example, each final segment represents a sensitivity tier (0-20%, 21-40%, 41-60%, 61-80% and 81-100%)

Once a set of final segments has been generated based on the correlation-based sensitivity labels, the method 400 may end.

Once the sensitivity model is complete an optimal difference (e.g., decrease or increase) from the resource allocation in the initial proposal for a new recipient can be identified from the sensitivity model by (i) mapping the new recipient to one of the final segments based on the recipient attributes and (ii) identifying a difference for the new recipient based on the final segment mapped to the new recipient.

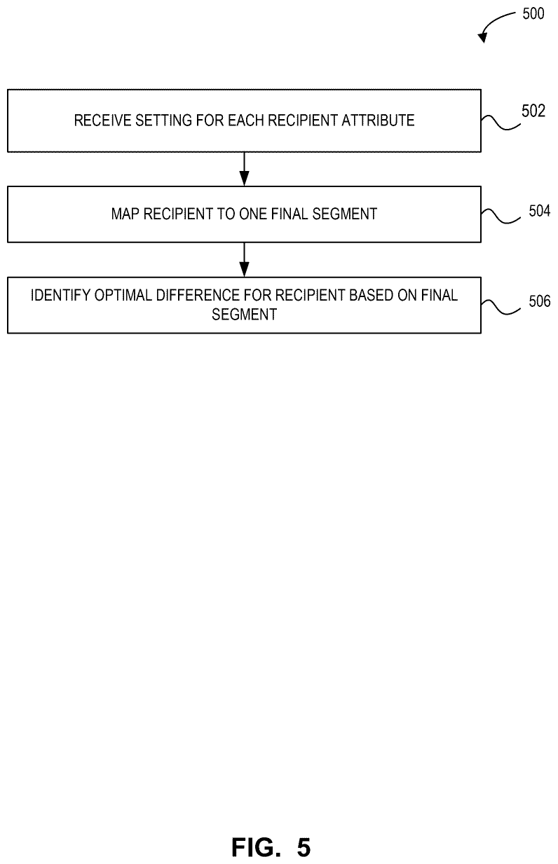

Reference is now made to FIG. 5 which illustrates an example method 500 of determining, from a sensitivity model generated in accordance with the method 300 of FIG. 3, a difference (e.g., decrease or increase) from a resource allocation in an initial proposal for a new recipient to form an updated proposal. The method 500 of FIG. 5 may be implemented by, for example, the adjustment module 110 of FIG. 1.

The method 500 begins at block 502 where the adjustment module 110 receives (e.g., via a graphical interface or otherwise) a setting for each recipient attribute of the one or more relevant recipient attributes for the new recipient (e.g., customer or process). For example, if the set of relevant recipient attributes comprises the six recipient attributes described above (rental, days before closing, builder indicator, construction type, term, and loan amount) then the adjustment module 110 receives a setting for each of those six recipient attributes. For example, the adjustment module 110 may receive information indicating rental=N, days before closing=60+days, builder indicator=N, construction type=detached, term=5 year fixed, loan amount=$500,000−$550,000. Once a setting for each relevant recipient attribute has been received for the new recipient the method 500 proceeds to block 504.

At block 504, the adjustment module 110 determines, based on the relevant recipient attribute settings received in block 502, which final segment (e.g., which sensitivity tier or sensitivity level) of the sensitivity model the new recipient falls within or is associated with. This process may be described as mapping the new recipient to a final segment of the sensitivity model based on the recipient attributes.

Specifically, each final segment will be associated with a set of historical records. Each historical record will have a setting for each of the recipient attributes. If the new recipient has the same settings for each of the recipient attributes as one of the historical records in a final segment, then the new recipient is said to fall within, or be associated with, that final segment. For example, if a final segment comprises a historical record with the following settings for the six relevant recipient attributes described above—rental=N, days before closing=60+days, builder indicator=N, construction type=detached, term=5 year fixed, loan amount=$500,000−$550,000—and the new recipient has the same settings for the recipient attributes (i.e., rental=N, days before closing=60+days, builder indicator=N, construction type=detached, term=5 year fixed, loan amount=$500,000−$550,000) then the new recipient falls within, or is associated with, that final segment. Once the new recipient has been mapped to a final segment of the sensitivity model based on the recipient attributes, the method 500 proceeds to block 506.

At block 506, the adjustment module 110 identifies an optimal or recommended difference (e.g., decrease or increase) from the resource allocation in the initial proposal based on the final segment that the recipient is mapped to. In some cases, the adjustment module 110 may be configured to determine the optimal difference based on the sensitivity tier or sensitivity level associated with the final segment based on, for example, a NIAT (net income after tax) vs difference plot. In other cases, the sensitivity model associates each final segment (and thus each sensitivity tier or level) with an optimal difference (e.g., decrease or increase) from the resource allocation in the initial proposal and the adjustment module 110 identifies this difference as the optimal or recommended difference from the resource allocation in the initial proposal for the new recipient. For example, if the sensitivity model associates the final segment identified in block 504 with an optimal or recommended difference (e.g., decrease or increase) of 0.5 then the adjustment module 110 may identify 0.5 as the recommended difference (e.g., decrease or increase) from the resource allocation in the initial proposal for the new recipient (e.g., customer). In some cases, the identified optimal or recommended difference from the resource allocation in the initial proposal for the new recipient may be output and/or displayed (e.g., via a graphical user interface).

As described above, in some cases, the adjustment module 110 may provide a graphical user interface and the adjustment module 110 may be able to receive the settings for the relevant recipient attributes for a new recipient from a user via the graphical user interface and/or output the recommended or optimal difference (e.g., decrease or increase) from the resource allocation in the initial proposal to a user via the graphical user interface.

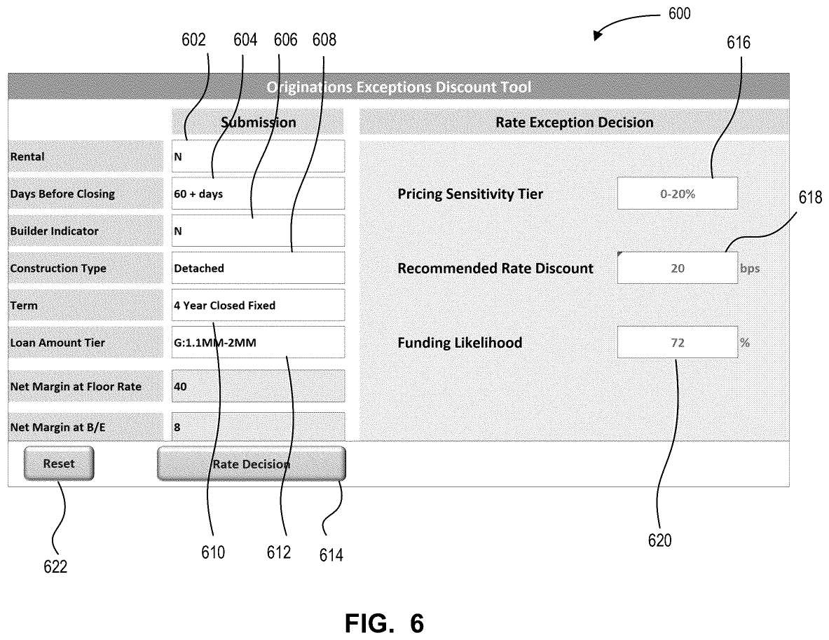

Reference is now made to FIG. 6 which illustrates an example graphical user interface 600 for identifying a recommended or optimal rate discount from an initial mortgage rate allocated to a customer in an initial proposal which may, for example, be provided by the adjustment module 110 of FIG. 1. In the example shown in FIG. 6, the relevant recipient attributes are the six recipient attributes described above (i.e., rental, days before closing, building indicator, construction type, term, and loan amount). To receive a recommended rate discount for a new recipient (e.g., a customer), a user first enters (or otherwise inputs) a setting for each of these six recipient attributes in the graphical user interface 600. In the example, shown in FIG. 6 there is an input field 602, 604, 606, 608, 610, 612 for each recipient attribute which the user can use to enter or input the setting for that recipient attribute. In some cases, one or more of the input fields 602, 604, 606, 608, 610, 612 may be a free-form text field in which a user can type in the setting for a corresponding recipient attribute. In some cases, where one or more of the recipient attributes may have a fixed number of possible settings or options, one or more of the input fields 602, 604, 606, 608, 610, 612 may be implemented as a drop-down or otherwise selectable list from which a user can select one of the possible settings or options.

Once the user has entered a setting for each of the recipient attributes the user clicks, or otherwise activates, a “Rate Decision” button 614. This causes the adjustment module 110 to determine, from the settings for the relevant recipient attributes and the sensitivity model, a pricing sensitivity tier (e.g., final segment), which is 0-20% in this example, associated with the new recipient (e.g., customer) and a recommended rate discount, which is 20 basis percentage points (bps) in this example. The determined pricing sensitivity tier and the recommended rate discount may then be display to the user in first and second display fields 616 and 618 of the graphical user interface 600. In some cases, the adjustment module 110 may also determine the funding likelihood and display this in a third display field 620 of the graphical user interface 600. As shown in FIG. 6, in some cases, the user may be able to clear or reset the settings in the input fields 602, 604, 606, 608, 610, 612 and/or display fields 616, 618, 620 by clicking or otherwise selecting a “Reset” button 622 in the graphical user interface 600.

### Test Results

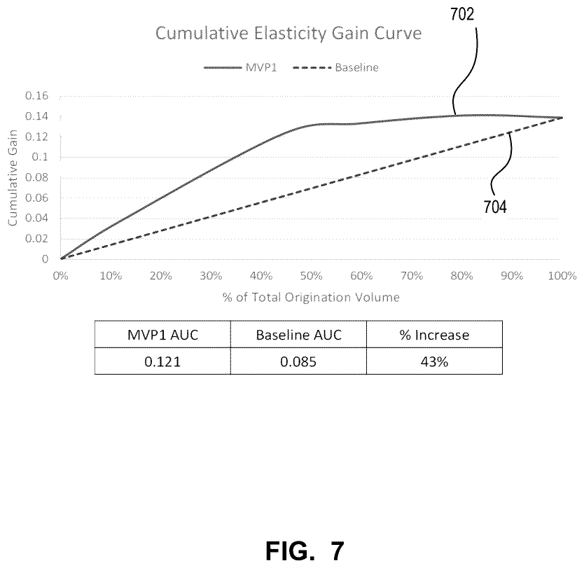

Testing has shown that generating a rate sensitivity model as described above with respect to FIGS. 3 and 4 for mortgage rates and selecting a reduction to an initial rate (e.g., floor rate) allocated in an initial proposal based on the generated rate sensitivity model significantly improves performance vs a baseline where rates are randomly assigned. Specifically, reference is now made to FIG. 7 which illustrates a cumulative elasticity gain curve 702 when a rate sensitivity model is generated (which may be referred to as the segmentation cumulative elasticity gain curve) and a cumulative elasticity gain curve 704 for the baseline case (which may be referred to herein as the baseline cumulative elasticity gain curve). Elasticity is defined as the ratio in the change in funding ratio (percentage of mortgages funded) and the change in the discount from the initial rate (e.g., floor rate) and can be expressed by equation (1).

$$Elasticity = \frac{Δ Funding Ratio}{ΔDiscount From Floor} \qquad ( 1 )$$

Elasticity quantifies the increase in the funding ratio if a larger discount was given. The segmentation cumulative elasticity gain curve 702 shows the level of elasticity captured by the segmentation for each proportion of the total mortgages. The goal of the cumulative elasticity gain curves 702, 704 is to evaluate how good the segmentation is at ordering elasticity. The better the segments are at ordering elasticity, the more the segmentation cumulative elasticity gain curve 702 will diverge from the baseline cumulative elasticity gain curve 704 and thus the area under the segmentation cumulative elasticity gain curve 702 (identified in FIG. 7 as “MVP1 AUC”) will be greater than the area under the baseline cumulative elasticity gain curve 704 (identified in FIG. 7 as “Baseline AUC”). It can be seen in FIG. 7 that the described segmentation method performs 43% better (using the area under the curve (AUC) metric) than the baseline.

### Example Computer

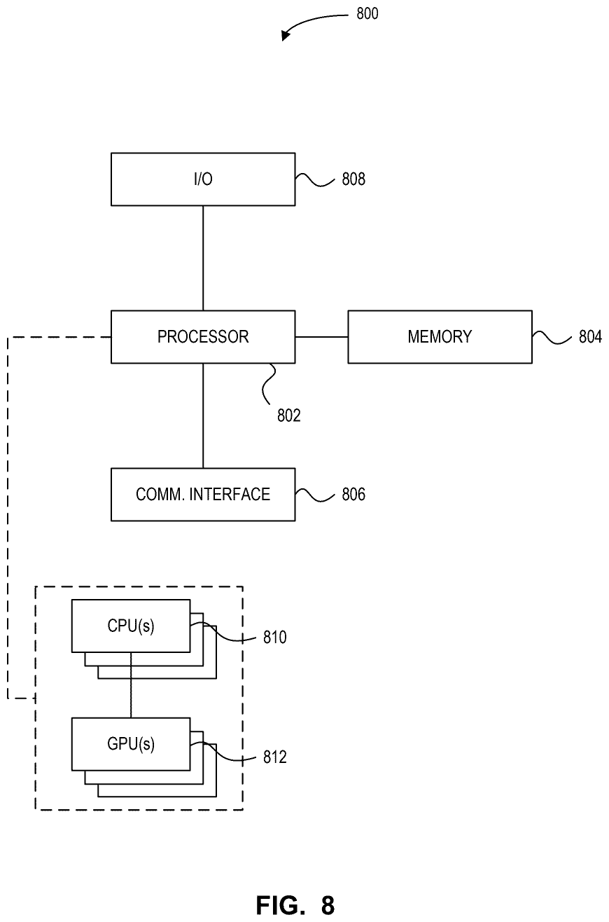

Reference is now made to FIG. 8 which illustrates a simplified block diagram of an example computer 800. Computer 800 is an example implementation of a computer which may implement all or a portion of the computing system 100 of FIG. 1 (e.g., implement the model generation module 102 and/or the adjustment module 110 of FIG. 1); all or a portion of the method 300 of FIG. 3; all or a portion of the method 400 of FIG. 4; and/or all or a portion of the method 500 of FIG. 5. Computer 800 has at least one processor 802 operatively coupled to at least one memory 804, at least one communications interface 806 (also referred to herein as a network interface), and at least one input/output (I/O) device 808.

The at least one memory 804 includes a volatile memory that stores instructions executed or executable by the processor 802, and input and output data used or generated during execution of the instructions. The memory 804 may also include non-volatile memory used to store input and/or output data—e.g., within a database—along with program code containing executable instructions.

The processor 802 may transmit or receive data via the communications interface 806 and may also transmit or receive data via any additional input/output device 808 as appropriate.

In some cases, the processor 802 may include a system of central processing units (CPUs) 810. In other cases, the processor 802 includes a system of one or more CPUs 810 and one or more Graphical Processing Units (GPUs) 812 that are coupled together.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for determining a difference from a resource allocation in an initial proposal for a recipient to form an updated proposal for the recipient, the system comprising:
a memory, a communication interface, and at least one processor operatively coupled to the memory and the communication interface;
the at least one processor configured to:
generate a sensitivity model by:
obtaining a set of one or more recipient attributes,
obtaining a plurality of historical records, each historical record comprising information indicating: a difference between a resource allocation in an initial proposal and an updated proposal for a historical recipient, whether the resource was provided to the historical recipient, and settings for the set of one or more recipient attributes, and
sub-dividing the plurality of historical records into a plurality of final segments using statistical analysis such that historical records in a same final segment have settings for the set of one or more recipient attributes that are correlated with a similar level of sensitivity to the difference between the resource allocation in the initial proposal and the updated proposal; and
select a difference from the resource allocation in the initial proposal for the recipient based on the sensitivity model.

2. The system of claim 1, wherein selecting the difference from the resource allocation in the initial proposal for the recipient based on the sensitivity model comprises:
receiving, for the recipient, a setting for each recipient attribute in the set of one or more recipient attributes;
mapping, based on the settings for the set of one or more recipient attributes, the recipient to a final segment; and
identifying the difference from the resource allocation in the initial proposal for the recipient based on the final segment mapped to the recipient.

3. The system of claim 2, wherein generating the sensitivity model further comprises associating each final segment with a difference from the resource allocation in the initial proposal; and identifying the difference from the resource allocation for the recipient based on the final segment mapped to the recipient comprises identifying the difference from the resource allocation in the initial proposal associated with the final segment mapped to the recipient as the difference from the resource allocation in the initial proposal for the recipient.

4. The system of claim 1, wherein each final segment of the plurality of final segments is associated with a different sensitivity tier of a plurality of sensitivity tiers.

5. The system of claim 1, wherein sub-dividing the plurality of historical records into the plurality of final segments using statistical analysis comprises:
sub-dividing the plurality of historical records into a plurality of segments, wherein all the historical records in a same segment of the plurality of segments have a same set of settings for the set of one or more recipient attributes;
performing a correlation analysis on the historical records within each segment to identify a relationship between (i) the difference between the resource allocation in the initial proposal and the updated proposal and (ii) providing the resource to the historical recipient;
assigning each segment a correlation-based sensitivity rating based on the correlation analysis;
dividing the segments into a plurality of correlation-based groups based on the correlation-based sensitivity ratings; and
combining the segments in each correlation-based group of the plurality of correlation-based groups to form the final segments.

6. The system of claim 5, wherein performing the correlation analysis on the historical records in a segment comprises calculating a correlation coefficient based on the historical records in the segment, wherein the correlation coefficient represents a relationship between (i) the difference between the resource allocation in the initial proposal and the updated proposal, and (ii) and providing the resource to the historical recipient.

7. The system of claim 6, wherein the correlation coefficient is a Pearson correlation coefficient.

8. The system of claim 6, wherein the correlation-based sensitivity rating for each segment is equal to the correlation coefficient for that segment.

9. The system of claim 5, wherein dividing the segments into the plurality of correlation-based groups based on the correlation-based sensitivity ratings comprises dividing the segments into quintiles based on the correlation-based sensitivity ratings.

10. The system of claim 5, wherein sub-dividing the plurality of historical records into the plurality of final segments using statistical analysis further comprises, prior to performing the correlation analysis:
assigning each segment a discretion-based sensitivity rating based on the differences between the resource allocation in the initial proposal and the updated proposal in the historical records in that segment;
dividing the segments with less than a predetermined number of historical records into a plurality of discretion-based groups based on the discretion-based sensitivity rating; and
combining the segments in each discretion-based group to form a new segment.

11. The system of claim 10, wherein the discretion-based sensitivity rating for each segment is an average difference between the resource allocation in the initial proposal and the updated proposal in the historical records in that segment.

12. The system of claim 1, wherein the resource is a financial resource, and the initial proposal allocates an initial price or rate for the financial product.

13. The system of claim 1, wherein the resource is a mortgage for a property, the initial proposal allocates an initial rate for the mortgage, and the difference from the resource allocation in the initial proposal and the updated proposal is a discount from the initial rate for the mortgage.

14. The system of claim 13, wherein the set of one or more recipient attributes comprises one or more of: whether or not the property is a rental property, a number of days before a closing of the property, whether the recipient is a builder, a construction type of the property, a term type of the mortgage, and an amount of the mortgage.

15. The system of claim 1, wherein the set of one or more recipient attributes comprise X recipient attributes that are most statistically significant to sensitivity and X is an integer greater than or equal to one.

16. A method for determining a difference from a resource allocation in an initial proposal to form an updated proposal, the method executed in a computing environment comprising one or more processors, a communication interface, and memory, and the method comprising:
generating a sensitivity model by:
obtaining a set of one or more recipient attributes,
obtaining a plurality of historical records, each historical record comprising information indicating: a difference between a resource allocation in an initial proposal and an updated proposal for a historical recipient, whether the resource was provided to the historical recipient, and settings for the set of one or more recipient attributes, and
sub-dividing the plurality of historical records into a plurality of final segments using statistical analysis such that historical records in a same final segment have settings for the set of one or more recipient attributes that are correlated with a similar level of sensitivity to the difference between the resource allocation in the initial and updated proposals; and
selecting a difference from the resource allocation in the initial proposal for the recipient based on the sensitivity model.

17. The method of claim 16, wherein selecting the difference from the resource allocation in the initial proposal for the recipient based on the sensitivity model comprises:
receiving, for the recipient, a setting for each recipient attribute in the set of one or more recipient attributes;
mapping, based on the settings for the set of one or more recipient attributes for the recipient, the recipient to a final segment; and
identifying the difference from the resource allocation in the initial proposal for the recipient based on the final segment mapped to the recipient.

18. The method of claim 16, wherein sub-dividing the plurality of historical records into the plurality of final segments using statistical analysis comprises:
sub-dividing the plurality of historical records into a plurality of segments, wherein all the historical records in a same segment of the plurality of segments have a same set of settings for the set of one or more recipient attributes;
performing a correlation analysis on the historical records within each segment to identify a relationship between (i) the difference between the resource allocation in the initial proposal and the updated proposal, and (ii) providing the resource to the historical recipient;
assigning each segment a correlation-based sensitivity rating based on the correlation analysis;
dividing the segments into a plurality of correlation-based groups based on the correlation-based sensitivity ratings; and
combining the segments in each correlation-based group of the plurality of correlation-based groups to form the final segments.

19. The method of claim 18, wherein sub-dividing the plurality of historical records into the plurality of final segments using statistical analysis further comprises, prior to performing the correlation analysis:
assigning each segment a discretion-based sensitivity rating based on the differences between the resource allocation in the initial proposal and the updated proposal in the historical records in that segment;
dividing the segments with less than a predetermined number of historical records into a plurality of discretion-based groups based on the discretion-based sensitivity rating; and
combining the segments in each discretion-based group to form a new segment.

20. A non-transitory computer readable medium storing computer executable instructions which, when executed by at least one computer processor, cause the at least one computer processor to carry out a method of determining a difference from a resource allocation in an initial proposal for a recipient to form an updated proposal, the method comprising:
generating a sensitivity model by:
obtaining a set of one or more recipient attributes,
obtaining a plurality of historical records, each historical record comprising information indicating: a difference between a resource allocation in an initial proposal and an updated proposal for a historical recipient, whether the resource was provided to the historical recipient, and settings for the set of one or more recipient attributes, and
sub-dividing the plurality of historical records into a plurality of final segments using statistical analysis such that historical records in a same final segment have settings for the set of one or more recipient attributes that are correlated with a similar level of sensitivity to the difference between the resource allocation in the initial and updated proposals; and
selecting a difference from the resource allocation in the initial proposal for the recipient based on the sensitivity model.
